(19) United States
(12) Patent Application Publication
(10) Pub. No.: US 2002/0082941 A1
(43) Pub. Date: Jun. 27, 2002

(54) Method and system for the dynamic delivery, presentation, organization, storage, and retrieval of content and third party advertising information via a network

(76) Inventor: Benjamin David Arthur Bird, Santa Monica, CA (US)

Correspondence Address: BENJAMIN D. BIRD, 1137 6TH ST. #302, SANTA MONICA, CA, 90403, US

(21) Appl. No.: 09/978,813

(22) Filed: Oct. 15, 2001

Related U.S. Application Data
(60) Provisional application No. 60/240,076, filed on Oct. 16, 2000.

(51) Int. Cl. G06F 17/60

(52) U.S. Cl. 705/26

(57) ABSTRACT

Content and advertising information is delivered electronically over a network such as the Internet in a manner enabling users to store one or more of the advertisements in one or more searchable repositories in a computer system for future retrieval. Users may store one or more advertisements without leaving the current page of information being displayed. Only the user may elect to store an advertisement. When a retrieval query from a user is received, the stored advertisements for that user are returned to the user via a web browser or similar software. Each user may maintain one or more lists of their stored advertisements and may append additional information to each stored advertisement or organize them by topic if desired. Users may also elect to transmit one or more stored advertisements to one or more recipients via email or similar electronic means. In one embodiment of the invention, advertisers provide dynamic offer terms for specific advertisements based upon variable criteria such as a profile of the user or the time duration between the initial display and the user's subsequent response to such advertisement.

Along with other information, Internet information providers can provide advertisements (“ads”) to users in a number of forms, one of which is known as a “banner” on a web page, often at the top of the page. A banner ad can have text and still or moving graphics, and typically serves as an HTML (HyperText Markup Language) link, such that the user is linked to another specified page if the user clicks on the banner. An HTML link is the typical response mechanism used in online advertising today e.g the user clicks on the ad banner and is linked to another specified web page. It is typical for more than one ad to be displayed an a particular web page at one time; however, the HTML link response mechanism only allows the user to respond to one advertisement. This limitation prevails despite increasing use of additional advertisements such as buttons and interstitials.

Users of the Internet today are severely limited in their ability to respond to an online advertisement. Typically, users are each engaged in some primary activity (e.g. checking email, surfing the web, chatting, etc.). If the user's primary activity comprises multiple pages of information, such as reading email, the advertisements served on each of those pages are only accessible while the user is viewing that particular page. In order to actually respond to a banner ad, the user is forced to deviate from their primary activity by clicking on the banner and going to a different web page. The act of responding to an online advertisement is made more problematic by the inability of a user to control which advertisement may be displayed on a particular page. That is to say, while the user may control the viewing of the page via use of a Universal Resource Locator (URL) address for the page itself, the decision regarding which advertisement is displayed is typically controlled by a third party such as the web site publisher or an advertising distribution company, often in response to criteria other than the URL address of the page itself. Therefore, a particular advertisement is not necessarily associated with a particular page and may be in fact viewed only once by a user despite multiple occurences of viewing the same page of information.

Use of the Internet and in particular, the World Wide Web, has grown substantially over the past five years. Recent studies suggest that the content available via the World Wide Web network is growing at a rate of over three million new pages of information per day. Published estimates put the current total of web pages at over 1.1 billion pages in the aggregate. Online advertising inventory comprises a substantial proportion of these pages, whereby pages include advertising information presented on behalf of either the content provider or a third party. The state of the art of online advertising primarily encompasses two delivery methods known by those skilled in the art as banner and interstitial. Banner advertisements represent a formatted subsection, such as 468×80 pixels or 88×31 pixels for example, of a web page carrying secondary advertising content. Interstitials are contructed with the advertisement itself serving as the primary information on a separate and distinct web page. Online advertising response rates for both major delivery methods have trended downward to under one percent on average. During the delivery of banner advertisements, users are often focused upon other activities relevant to the primary page content such as searching, reading, viewing animation or video streams, chatting, playing interactive games, or composing email. The decision proposition that is forced upon the user—whether or not to discontinue a current activity and click through a banner advertisement—is a substantial impediment to the success of the interactive advertising and product marketing methods in use today. A system and method is needed to improve the effectiveness of advertising via the Internet, World Wide Web, and other online networks. Those skilled in the art will recognize that email-based advertising is emerging as a successful implementation of online marketing in part due to the ability of a user to store message information for reference at a future time.

One option for online advertising is the activity of viewing pages via the World Wide Web as shown in FIG. 10. A user views one or more web pages via browser software over a network connection. Each page of information may include one or more paid advertisement offers such as Advertisement A in FIG. 10. Although the delivery format of these offers is inconsistent, they are often displayed in one or more standardized size formats such as 468×80 pixels. The user clicks on an advertisement to respond, either replacing the page in the current browser window or spawning a new browser window to display the advertisement. Those skilled in the art will recognize that the prior art does not offer the user a means to respond directly to an advertisement once the user has progresssed to a new world wide web page as shown in FIG. 11. The opportunity to respond to an advertisement is limited directly to the time that a user is exposed to it. In other words, the decision to respond must be made quickly and is not portable beyond the display of the current world wide web page.

Another option is the activity of viewing programming via cable, satellite, broadcast or other means. A viewer typically receives content such as a movie, news program, or entertainment program by selecting from an array of available channels. Content often includes advertisements in the form of commercials, and in some cases the content may even consist entirely of paid promotional programming. Those skilled in the art will recognize that TiVo, for example, is offering a manner of recording programming; otherwise there is no manner for users to retain advertisement information delivered by the system.

Another option is the activity of sending and receiving information via either electronic mail or chat. Email and chat are substantially similar because in both cases a user types or otherwise inputs a text message which is transmitted to one or more recipients for onscreen display. Email and chat are substantially dissimilar in terms of mechanism: email follows open programming standards, for example, while chat is generally conducted over closed programming protocols. Chat is used for realtime session communications whereas email is not typically used for single session interactive communications. Email by design enables users to retrieve previously viewed material and is therefore of consideration in this patent application only to the extent of incorporation via the messaging server component described more fully later in the specification.

It has been known in the prior art that sets of bookmarks or Universal Resource Locators (URLs) may be used as an advertising medium as disclosed in U.S. Pat. No. 6,247,021 to Internation Business Machines. However, it has not been disclosed how users may be permitted to assemble their own sets of bookmarks or URLs or how to deliver content and advertising information in such as a way as to facilitate such user-controlled assembly of information.

It would be desirable for users of the Internet and other networks to have an efficient way to store ads for future consultation and use.

The present invention enables users to choose a better time to view selected banner advertisements. The user controls the future timing of these advertisement impressions, as well as the context. A primary aspect of the present invention is the ability to give viewers greater viewing flexibility while providing advertisers with new and novel opportunities for interaction with viewers.

### SUMMARY OF THE INVENTION

The present invention is an advertising system and method for use with a large network, such as the Internet, and a plurality of users. The invention provides a method giving users direct, dynamic control of content and advertising information received from a third party. To address limitations existing in the prior art, a system is provided that permits users to save individual content, advertising, marketing, and coupon offers from a plurality of sources and store such information for subsequent retrieval and manipulation. The invention provides a new and novel interaction framework among users of a network whereby specific advertisements and marketing offers delivered alone or in conjunction with other content information, from one or more sources, may be designated and saved by users for future reference.

In other words, the present invention is directed to an interactive system and method comprising the delivery, selection, acquisition, storage, retrieval, organization, and transmission of content information including advertisement information and marketing offers via an online network. Accordingly, the system according to the present invention includes some or all of the following major components: a computer-mediated communications network for connecting users and sending content and subscriber data to and from the application servers, an online account manager for identifying and authenticating users of the system, an online delivery manager for delivering content and advertising information to users via the computer-mediated communications network, an online retrieval manager for retrieving content and advertising information data for delivery to users via the computer-mediated communications network, an on-line acquisition manager for managing responses to network and user requests and gathering and storing content and advertisement information data, an information warehouse manager for processing and analyzing third party data and data generated by the system, an online messaging manager for effecting transmission of content information and advertising data, and a reporting manager for logging, computing and outputting system data and metrics.

It is an object of the present invention to deliver advertising information to any number of individual users (referred to here as “viewers”) in a manner allowing each individual viewer to capture and store such advertising information. The system thereby enables viewers to retrieve one or more stored lists of advertisements at a future time.

The present invention permits ads to be selected and stored by users for subsequent retrieval, Each user is able to create and maintain one or more personalized lists of advertisements and is able to append additional, user-defined information such as notes and comments to thir lists. Additionally, users are able to transmit one or more of their lists to others via email. It is therefore easy to envision a simple system where users elect to “save” an ad for review at a later time instead of either interupting their primary activity or ignoring the advertisement.

The present invention provides an integrated system which allows advertisements to be served in an improved manner that enables viewers to select and store particular advertisements for future retrieval, rather than being abandoned after the user proceeds to the next web page. Different delivery formats can be served based on different definable criteria, such as the location of the user, the nature of the information being accessed by the user, or the length of the advertising campaign or coupon offer.

The invention can be used for digital marketing offers such as online coupons. In this embodiment, the advertisement consists of a special offer redeemable by clicking on the banner. For example, an advertiser might offer $25 off a sweater if purchased by a specified date. This advertiser might elect to specify further that the offer increases to $35 if certain conditions are met, such as prior forwarding of the advertisement by the user to at least two other people, for example.

These and other objects, features, and advantages of the present invention will become more apparent in view of the following detailed description, drawings and claims.

### DESCRIPTION OF THE DRAWINGS

The accompanying drawings, which are incorporated in and constitute a part of this specification, illustrate embodiments of the invention and together with the description, serve to explain the principles of the invention.

FIG. 1 is a block diagram overview of the elements and operations consistent with the present invention.

FIG. 2 is a detailed diagram of the computer-mediated communications network 10 component consistent with the present invention.

FIG. 3 is a detailed diagram of the account manager 20 component consistent with a preferred embodiment of the present invention.

FIG. 4 is a detailed diagram of the information warehouse manager 30 component consistent with a preferred embodiment of the present invention.

FIG. 5 is a detailed block diagram of the online delivery manager 40 component consistent with a preferred embodiment of the present invention.

FIG. 6 is a detailed diagram of the acquisition manager 50 component consistent with a preferred embodiment of the present invention.

FIG. 6a is a detailed diagram of the acquisition manager 505 component design.

FIG. 7 is a detailed diagram of the retrieval manager 60 component consistent with a preferred embodiment of the present invention.

FIG. 8 is a detailed diagram of the reporting manager 70 component consistent with a preferred embodiment of the present invention.

FIG. 9 is a detailed diagram of the messaging server 80 component consistent with a preferred embodiment of the present invention.

FIG. 10 illustrates the current state-of-the-art process of viewing a web page and responding to a banner advertisement.

FIG. 11 identifies an important limitation of the current state-of-the-art process of responding to an online advertisement.

FIG. 12 is a functional overview of an important improvement over the prior art with regard to user control of online advertising.

### DETAILED DESCRIPTION OF THE INVENTION

The present invention will now be described according to the preferred embodiment of the present invention and in connection with the accompanying figures and technical diagrams.

The invention comprises a system and method for delivering units of content and advertising information via a computer-mediated communications network in a manner enabling users of the system to select, store, retrieve, and transmit discrete units of content and advertising information as are presented by the system.

The invention enables users of one or more electronic networks to capture the identification sequence for specific advertisements from any access node on the network. The invention enables users on a network to append original information to one or more specific advertisements The invention enables users on a network to control the display frequency of a potentially unlimited array of advertisements as well as organize and manipulate said array.

Overview

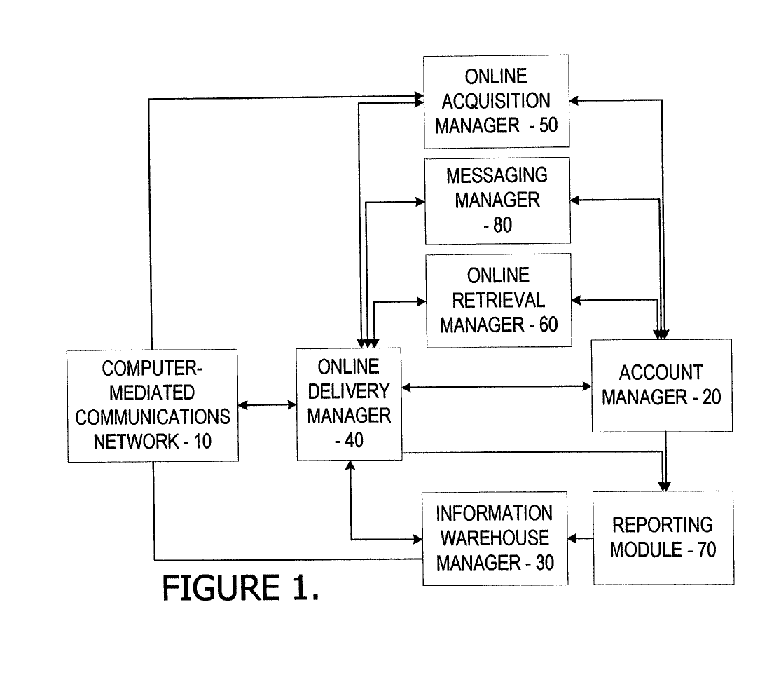

A preferred embodiment of the overview of the system is illustrated in FIG. 1. As shown, the system includes eight major components: the computer-mediated communications network 10, the account manager 20, the delivery manager 40, the retrieval manager 60, the deposit manager 50, the information warehouse manager 30, the reporting manager 70 and the messaging manager 80. As a whole the system provides a mechanism for users of the system to select, store, categorize, and retrieve specific content and advertising data delivered by the system for for future use, consultation and reference. The disclosed method also enables users to transmit specific content and advertising data delivered by the system to one or more recipients.

The Method

A plurality of information data comprising content, such as advertising information, is organized into specific delivery units (DUs) where each DU delivered to a user by the invention includes a unique identification sequence referred to as a “dynamic access identifier”. Since this unique identification sequence serves as a unique content locator, users are able to identify and manipulate specific content and advertising delivery units in an accurate manner.

The inclusion of the dynamic access identifier gives each user the ability to retrieve one or more particular advertisements or DUs. In one embodiment of the present invention, this method is used to permit users to respond to an advertisement at a later time instead of interrupting current browsing or viewing activity.

Those who are skilled in the art will appreciate that the function of delivering a dynamic access identifier is independent of the particular source and composition of the identified content information and will therefore recognize that an important aspect of the disclosed invention is the ability to operate over a wide range of content comprising all or any of text, graphics, video, audio, or other data file formats.

The System

FIG. 1 illustrates a preferred embodiment of the overall system according to the present invention. Components of the overall system including the computer-mediated communications network 10, the account manager 20, the acquisition manager 50, the retrieval manager 60, the delivery manager 40, the information warehouse manager 30, the reporting manager 70, and the messaging manager 80. A computer-mediated communications network 10 enables a plurality of users to connect with the system and exchange data requests and responses with the online delivery manager 40 to effect the display of content and advertisement information. The computer-mediated communications network 10 also enables users to communicate with an online acquisition manager 50 and an online retrieval manager 60 to exchange data requests and responses. The system utilizes an on-line account manager 20 for the management of account-specific data, for example, the exchange of user profile data, authentication of users or origination of new user data records as appropriate.

A more detailed description of the specific interaction between the major components of the system outlined above is provided below.

The Computer-Mediated Network 10

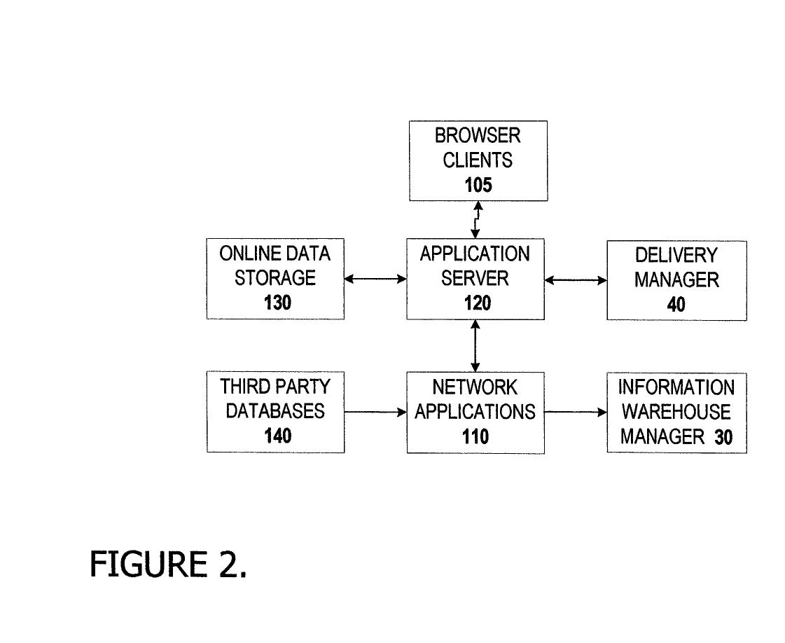

A more detailed diagram of the computer-mediated network 10 illustrating its connections to the other system components is shown in FIG. 2.

It is to be understood that the computer mediated network 10 can be embodied in a number of different ways, both now and hereafter known, and that the embodiment shown in FIG. 2 is a preferred realization of the network as contemplated by the present inventor.

The system is available via the network 10 to network applications 110 and users via browser clients 105. The application server 120 receives requests passed via the network interface 405 to the request broker 410. An online data storage 130 may be accessed by the application server.

The Account Manager 20

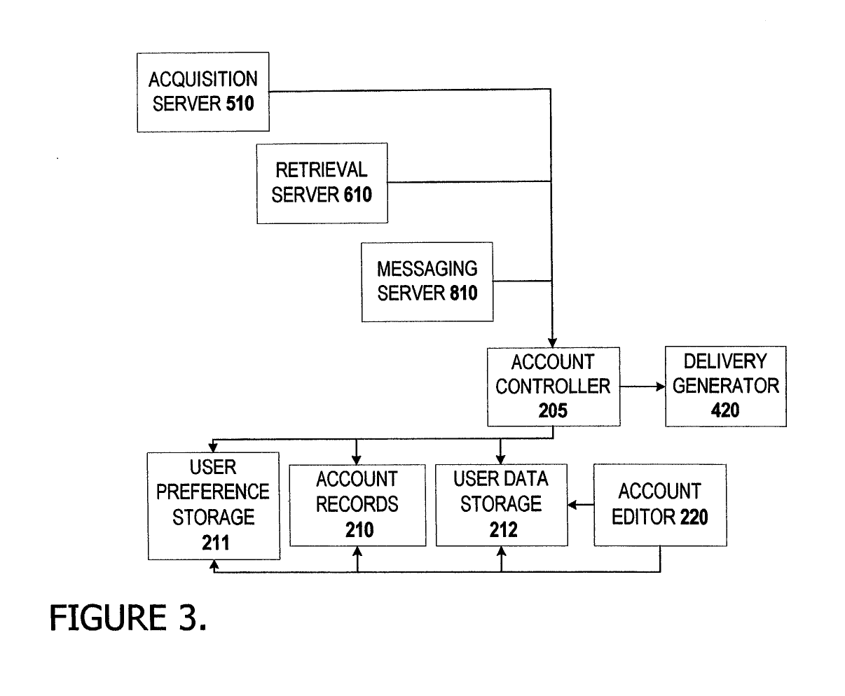

The account manager 20 will now be described in more detail in conjunction with FIG. 3.

The account manager comprises an account controller 205, data storage for account records 210, preference storage 211, user data storage 212, and an authentication registry to build, manage, edit, and administer user accounts on the system.

An account record is created for each new user of the system and stored in the account records data storage 210. The account record maintains general identification and descriptive information about the entity, the primary data for which is populated with basic identification data and attributes that are used by the system according to the present invention. User base entity data may include the following set forth in Table 1.

TABLE 1

| | |
|---|---|
| Field | Description |

| | |
|---|---|
| User_ID | Unique ID sequence |
| Network_User_ID | User ID |
| Network | the user's network |
| Income_lvl | Demographic data |
| Age | Demographic data |
| Date_added | First date of use |

The account editor 220 permits the editing of entity data via variable levels of editing authority established by a system administrator.

The account controller 205 responds to a variety of system calls. Each request passed to the request broker 410 for user-specific information (e.g. requests for data retrieval and acquisition, validation, authentication, data transmission, and account generation) calls the account controller 205 for differential processing. For example, the account controller 205 validates the authority of the current user to create a session control record in response to the user's login request. After comparing the user's credentials to the profile stored on the system in the account records data storage 210 and releasing approval, the account controller 205 creates a session control record and returns a valid user_ID to the calling application, in this case the retrieval server 610. In response to a user's acquisition request, the account controller 205 validates the identity and authority of the user before appending the valid user_ID to the data stored in the user data storage 212.

The account controller 205 is able to access the user profile storage 210 to retrieve a record matching on a unique User_ID.

In deployment systems for the World Wide Web, the account controller is able to utilize cookies to store user-specific session data for system use. This data may include encrypted or unencrypted information such as the User_ID and Session_date for the purpose of identifying a particular user or a particular storage or retrieval request.

The Information Warehouse Manager 30

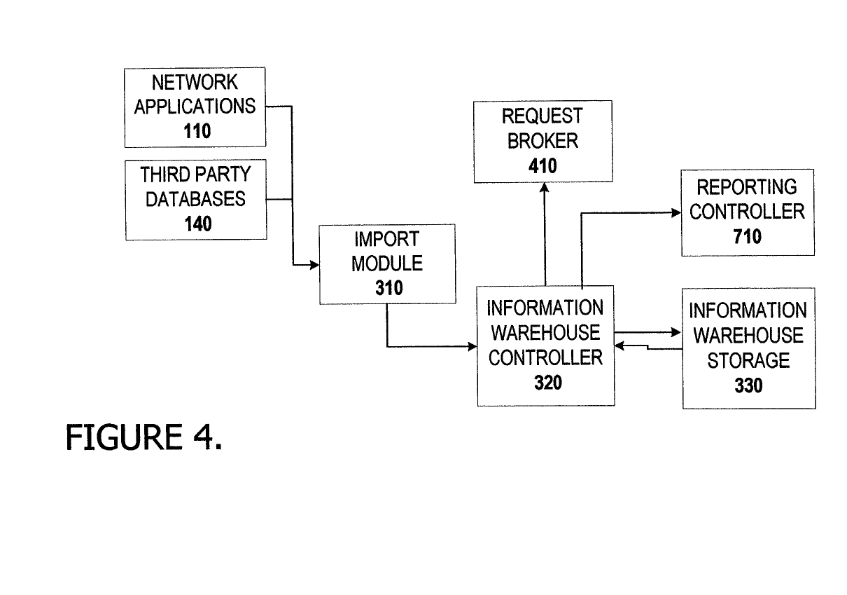

The Information Warehouse Manager will now be described in more detail in conjunction with FIG. 4. As shown, data from external sources such as the communications network 10 and third party databases 140 is loaded into the delivery manager 40 through the information warehouse manager. The information warehouse manager comprises an import module 310, an information warehouse controller 320, and an information warehouse storage 330. The retrieval manager 60 sends data to the information warehouse controller 320.

As shown in FIG. 4, the information warehouse storage includes session control records, source to destination mapping records and data source control records. The information warehouse controller includes an import session controller, a data source mapping module and a data source manager.

The information warehouse manager 30 may be implemented by employing any of several off-the-shelf commercial products.

The Online Delivery Manager 40

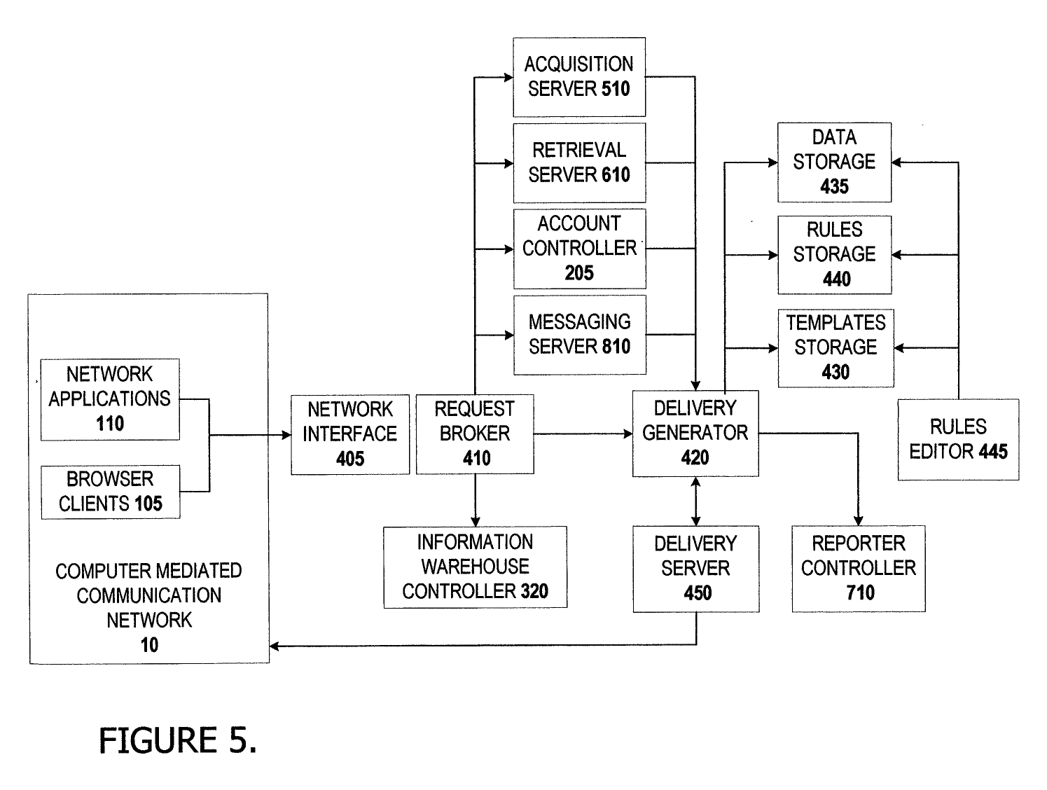

The Online Delivery Manager will now be described in conjunction with FIG. 5. As shown, the online delivery manager 40 includes a network interface 405, a request broker 410, a data storage 435, a delivery generator 420, a rules storage 440, an editor 445, and a delivery server 450.

The delivery manager is responsible for delivering content and advertisement information to the computer-mediated communications network in a manner than enables users to select and save specific content units for review at a later date. As such, each content unit delivered by the system is tagged with a unique retrieval identifier, referred to as a “dynamic access identifier”, to permit retrieval of said content unit from the system at another point in time.

The delivery manager exchanges data with the account controller 205 and may also receive input from the validation controller in response to retrieval requests. The network interface 405 exchanges data with the computer-mediated communications network. The delivery generator 420 is coupled to the data storage 435 as shown and also communicates to rules storage 440 and template storage 430. The rules in storage 440 can be updated from the editor 445.

The system takes data input from any number of data sources including third party databases, computer-mediated communications network providers, and the provider of the service based upon the present invention. It is to be understood that there are several data storage architectures that can be implemented to realize the invention. At one end of the spectrum of possible data storage schemes, all of the data storages are accessed by a relational database system such as commercial products currently available from Oracle, Microsoft, IBM, Sybase, or Informix among others. At the other end of the implementation spectrum, all of the data storages may be hand-rolled as relational files via a public domain flatfile or relational database system format such as Berkeley Systems DBM, AnyDBM, or GDBM and accessed via a variety of programming languages such as PHP, Perl, C++, Javascript, Java, or Basic. This implementation of the system will be feasible in cases where the total number of system users, advertisers, and content providers is relatively small. Once the data are loaded and housed in the database, they become available to the delivery generator 420 based upon delivery targeting criteria, such as a particular time period or to a particular set of users, which are stored as content delivery rules in the delivery rules storage 440.

The major components of the delivery manager will now be described in more detail.

Network Interface 405

The network interface 405 is the software and hardware connection to the online service and will vary depending on environmental factors such as protocol type and network topology. The network interface 405 listens for calls from client applications via the computer-mediated communications network 10. Requests are translated to the protocol used within the online delivery manager 40 and passed to the request broker 410 for processing.

Request Broker 410

The request broker 410 assigns a unique identification sequence to each request and also generates log entries describing each request. The destination for each request is determined by evaluating the request name; requests may be routed to either the retrieval manager 60, the delivery generator 420, the messaging server 80, or the acquisition manager 50.

When the request broker 410 receives a request to display advertising information, the request is passed to the delivery generator 420. Upon receiving a request to retrieve stored advertising information, request broker 410 passes the request to the retrieval controller 610. If the request broker 410 receives a request to send a message containing content and advertising information, the request is passed to the message controller 810.

Data Storage 435

The data storage 435 includes base entity data, rules, and templates, each of which is accessed via the editor 445 to add, update, or delete data records. For content and advertisement units, the base entity data stored in data storage 435 is provided either directly by the advertiser or by a system administrator. The base entity data for content and advertisements units will in all cases necessarily include a unique identification sequence, and may further include the following set forth in Table 2.

TABLE 2

| Field | Description |
|---|---|
| Content_ID | Unique ID sequence |
| Content Name | Content unit identity |
| Description | Description |
| Address | Network location |
| Rule_ID | Unique rule sequence |
| Valid_for | Validity interval |

Delivery Generator 420

The delivery generator 420 creates the data responses necessary to target content and advertising information. These responses are passed to the delivery server 450 for delivery to the end-user. In response to requests for content and advertising information, the delivery generator includes a unique identification sequence for delivery to the user. In this manner the user may identify and save the indicated content and advertising information for future reference.

Those skilled in the art will appreciate that the method in use today for delivering advertising is to deliver a graphic advertisement image, either alone or in conjunction with accompanying text, that is available via HTML link to a specific web page related to the advertisment. In cases where both image and text are provided, both the image and the text contain the same HTML link. The present invention differs from the state of the art in that the advertisements delivered each provide an additional HTML link to the acquisition interface thereby giving the user a choice of how to respond to the advertisement. The user may therefore click on the image and respond to the advertisement immediately or, alternatively, the user may click on the text and thereby select the advertisement for possible response at a later time. Those skilled in the art will recognize that the association of the multiple HTML links to either the image or the text is but a matter of preference and that the HTML links for the differential responses may be triggered interchangeably from either the image or text.

Template Storage 430

The template storage 430 provides a scalable repository for design and presentation templates that are used by the system. This design and presentation information may be effected in HTML, XML, SMIL, Flash or other formats.

Rules Storage 440

The rules storage 440 provides a scalable repository for storage of campaign- and content-specific validation rules.

Editor 445

The editor 445 provides the mechanism for system users, administrators, and advertisers to create and modify validation rules applicable for specific content and advertisement units. Rules may be time-based, realtime inventory-based, or based on any other condition specified by the rule editor.

Delivery Server 450

The delivery server 450 receives data responses from the delivery generator 420 and delivers them via the appropriate network protocol for the computer-mediated communications network 10. For example, the server would use hypertext transfer protocol (HTTP) for communicating with users via the World Wide Web.

The Acquisition Manager 50

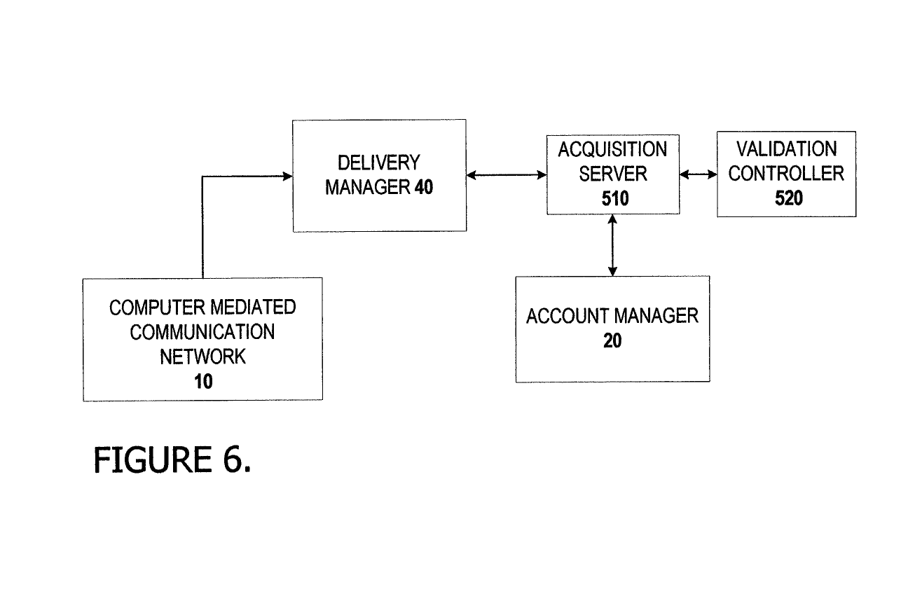

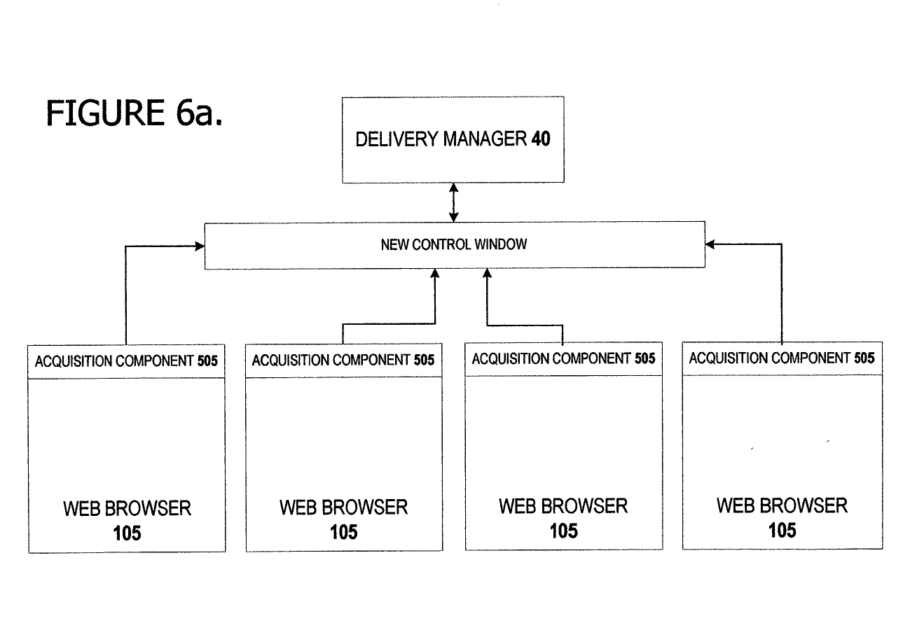

The acquisition manager 50 will now be described in more detail in conjunction with FIG. 6. As shown, the acquisition manager 50 consists of the acquisition server 510, the acquisition client 505, and a validation controller 520.

The acquisition manager responds to users' requests to save specific content units. It is designed to be available to the user at any time from any position or node on the network. It connects to the account manager 20 to request authentication or, in the case of new users, to originate a new user data record 210.

An acquisition server 510 provides the mechanism to execute data acquisition related to content or advertising information. The account controller 205 validates the identity of the current user, including authority according to valid session control records 240. Once the user has been verified, the acquisition request is processed. If the deposit is executed without error, the data is written to the user data storage 212 and a confirmation response is returned to the delivery generator 420. Any errors are written to the error log 730.

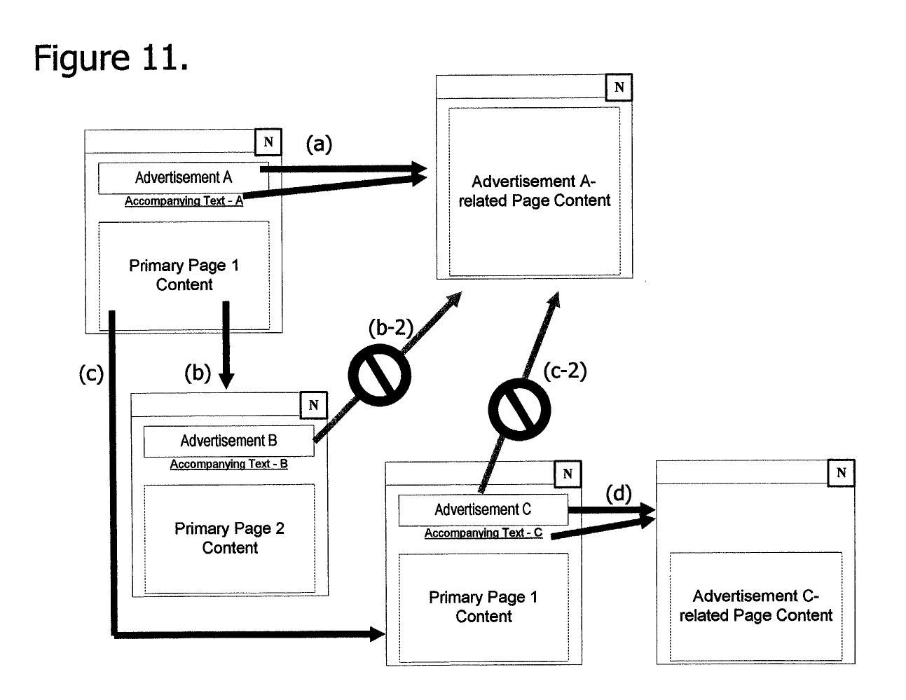

In a preferred embodiment of the present invention, the acquisition manager includes an acquisition client 505 composed of client-side computer code which is either standalone or integrated with a browser client application 105 to facilitate the practical use of the acquisition function. The acquisition client 505 illustrated in FIG. 6a. is a preferred embodiment of the present invention consisting of javascript code that is integrated with a web browser software application, for example either Netscape Navigator (America Online, Dulles, Va.) or Internet Explorer (Microsoft, Redmond, Wash.). The acquisition client 505 enables the user to contact the request broker 410 while maintaining the current view of any point on the World Wide Web, thereby overcoming the limitations in the prior art as depicted in FIG. 11.

The Retrieval Manager 60

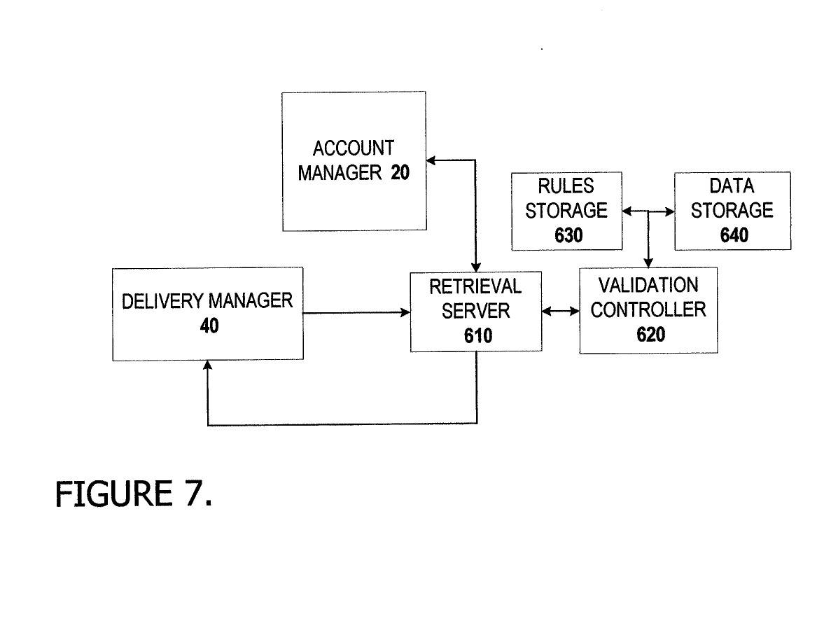

The retrieval manager will now be described in more detail in conjunction with FIG. 7. As shown, the retrieval manager consists of the retrieval server 610, the validation controller 620, and data storage 630.

The retrieval manager responds to users' requests to retrieve stored content and advertising information units. The result is a personalized list of content and advertisement information for the user identified in the request.

Retrieval requests are received by the retrieval controller which generates a query to the relational database engine to retrieve all records from the user data storage where the identification number matches the userID.

Retrieval requests are effected in the following manner:

A retrieval server 610 provides the mechanism to retrieve stored content information data. The account controller 205 validates the identity of the current user, including authority according to valid session control records 240. Once the user has been verified, the retrieval request is processed. The retrieval server 610 searches the relational database and selects all user data records 212 associated with a specific user. If the retrieval is executed without error, the response is returned to the delivery generator 420. Any errors are written to the error log 730.

The retrieval manager includes a validation module 620 that may be engaged to validate content data units against rules maintained in the rules data storage. When the validation module is engaged, the validation controller 620 accepts user data retrieval requests and matches them against validation rules that are stored in the rules storage 630. Individual validation rules may be specified by any user of the system such as advertisers, users, and administrators. administrators or users. When the validation controller detects a match between a content unit and a validation rule, the rule is applied to the data request. Based upon modifiers specified in applicable validation rules, data requests may be processed, passed unmodified, or even denied outright. The validation module may append information to specific records in retrieval requests, for example, to alert the user to an offer expiration.

The rule editor 625 provides the mechanism for system users, administrators, and advertisers to create and modify new validation rules governing specific content and advertisement units. Rules may be time-based, realtime inventory-based, or based on any other condition specified by the rule editor.

The Reporting Manager 70

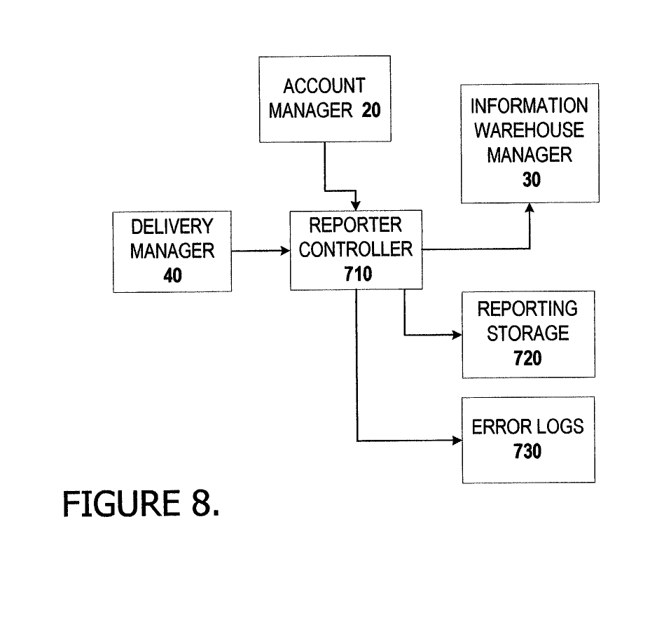

The reporting manager will now be described in more detail in conjunction with FIG. 8. As shown, the reporting manager 70 includes a reporting controller 710, a reporting storage 720, and an error log 730.

The reporting manager uses various data records along with data from the delivery generator 420 to produce and maintain aggregate and detailed system activity information.

The Messaging Manager 80

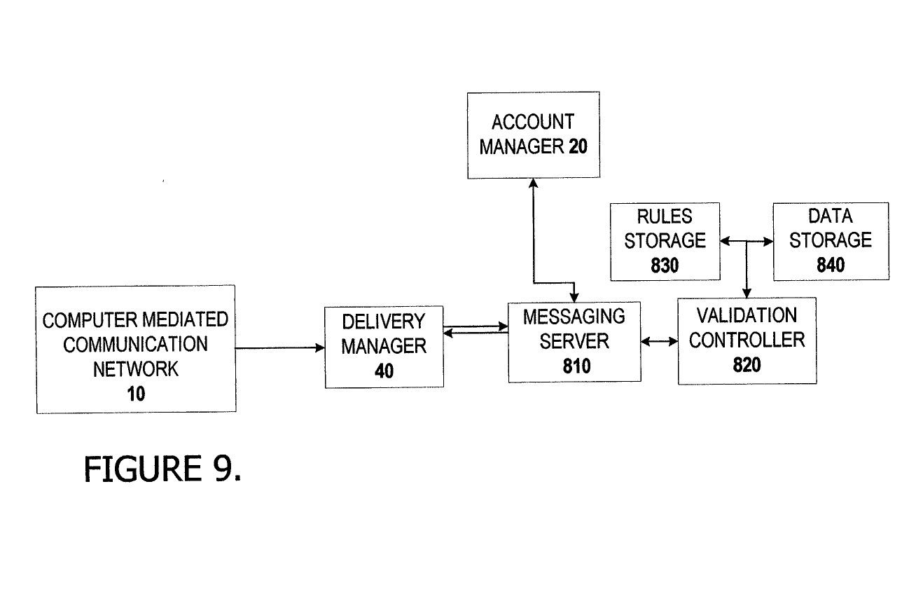

The messaging manager will now be described in more detail in conjunction with FIG. 9. As shown, the messaging manager 80 includes a messaging server 810, a validation controller 820, a rule storage 830, and a data storage 840. The messaging manager 80 allows users to transmit saved advertising and content information via email.

Messaging requests that reach the request broker are passed to a messaging server 810. The messaging server 810 provides the mechanism to execute messaging requests related to content or advertising information. Once the account controller 205 has validated the identity of the current user, including user authorities according to valid session control records 240, records in the user data storage 212 matching the user_ID as well as records in the user preference storage 211, are retrieved for inclusion in the user's message. The validation controller 820 accesses the data storage 840 and the rules storage 830 for validation rules to apply prior to outputting message data to a mail transport application (MTAP) such as UNIX sendmail. These rules may impose a limit on the maximum allowable size of a message, for example. Those who are skilled in the art will realize that message validation may also be carried out via the MTAP. The messaging server 810 adds confirmation of the processing response to the data returned to the delivery generator 420 and any errors are written to the error log 730.

Users may choose from several available message format options when transmitting a message, including a method of formatting included content and advertising information in a manner enabling the recipient to acquire and maintain the information for future manipulation without having to re-enter the information. This mechanism is accomplished by making one or more unique identification sequences for the content and advertising information available to the recipient of the message, thereby allowing the recipient to access the included information.

Users may receive compensation from an advertiser as a result of transmitting content and advertising information to other recipients:

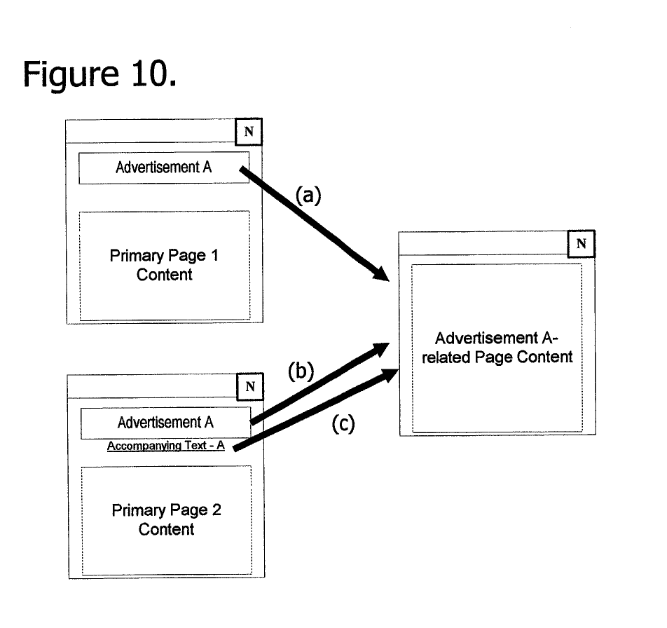

FIG. 10.

Advertisement A (468×80 pixels) included with a World Wide Web content page in one of two common formats: with text and without text. Clicking on the banner advertisement itself (a) or (b) brings the user to a new page containing content or advertising information related to the advertisement. Clicking on the accompanying text (c) achieves the same result.

FIG. 11.

Clicking on either the prominent advertisement A banner or its accompanying text (a) brings the user to a web page related to the advertisement. But if the user refreshes the existing page and receives a different advertisement (b) or moves to another page (c) altogether, the user can no longer respond to the previous Advertisement A (b-2 and c-2). Clicking on Advertisement C or its accompanying text (d) brings the user to a web page related to the advertisement.

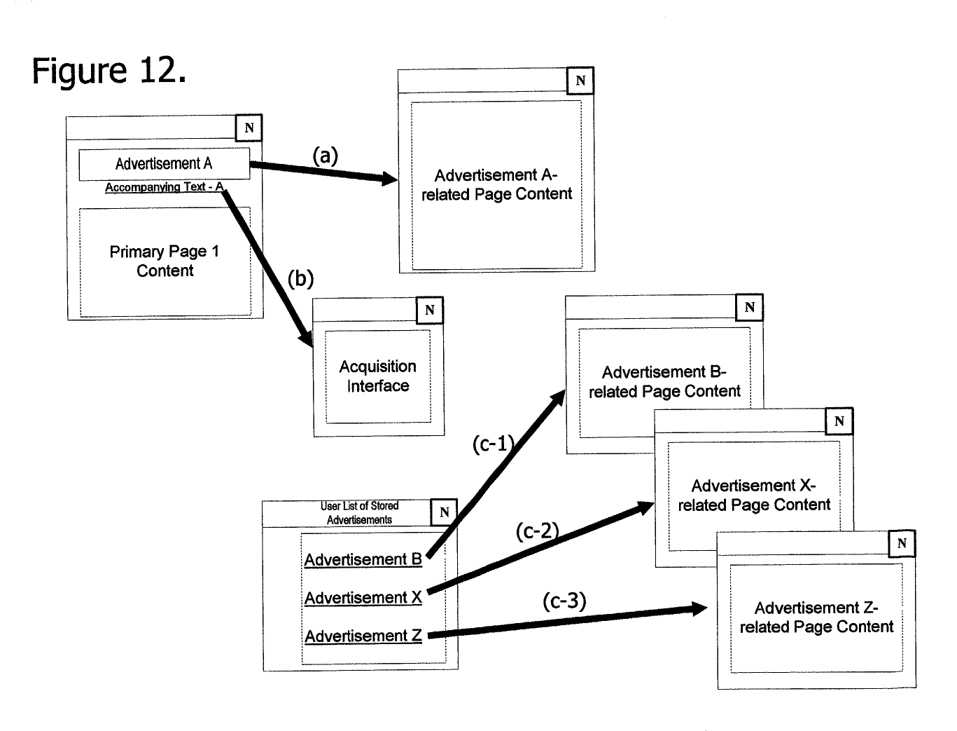

FIG. 12.

This diagram illustrates the novel functionality supplied by the present invention. A user is given the choice of either responding to the advertisement A immediately (a) by clicking directly on the advertisement, or selecting the advertisement for later review by clicking on the accompanying text (b). Clicking the text presents a separate acquisition interface through which the user may choose to add additional information to the selected advertisement. Upon successful acquisition, the user receives a confirmation of the successful operation.

The second part of FIG. 12 illustrates the process of a user retrieving a list of stored advertisements. The listing includes additional information previously appended to each advertisement by the user. By choosing any of the stored advertisements [(c-1), (c-2), (c-3)] the user is able to respond to that advertisement and is taken to the appropriate related web page.

The present invention has been disclosed with particular reference to the specific embodiments disclosed. One of ordinary skill in the art would be enabled by this disclosure to make modification to those embodiments and still be within the scope and spirit of the present invention as recited below in the following claims:

1. A method and system for the dynamic presentation, acquisition, storage, organization, and retrieval of one or more content and advertising information units delivered via a network.

2. A system and method according to claim 1 wherein one or more of the selection, acquisition, storage, organization, retrieval and manipulation capabilities including retransmission of content and advertising information is controlled by the user.

3. A system and method according to claim 1 wherein the acquisition management and retrieval management means are used to create and manage display definitions specific to each user of the system.

4. A system and method enabling users on a computer-mediated network to select, acquire, store, categorize, retrieve, manipulate, and transmit specific content and advertising information provided by one or more third parties.

5. A system and method according to claim 4 wherein content and advertising information is delivered electronically in a manner enabling viewers to retain specific content and advertising information for subsequent review and manipulation.

6. A system and method according to claim 4 wherein users may capture the current Universal Resource Locator (URL) of a web page or web site for further manipulation without leaving the current web page or web site.

7. A system and method according to claim 4 wherein additional data and information associated with a Universal Resource Locator (URL) is captured for further use by the user.

8. A system and method according to claim 4 wherein users may transmit one or more specific units of content and advertising information to one or more recipients.

9. A system and method according to claim 4 wherein users may transmit one or more content and advertising information channel locations to one or more recipients.

10. A system and method according to claim 4 wherein users may transmit one or more specific units of content and advertising information in a manner enabling one or more recipients to retain the transmitted content and advertising information in an editable form in a database or similar storage system without having to re-enter the content and advertising information data.

11. A method for user configurable content and advertising information management comprising the steps of: delivering content information in a specialized manner to a plurality of users of a network; providing said users with a means of designating specific content information for future reference and manipulation and establishing a link to that specific content information; and providing said users with a means of referring to and manipulating specific content information;
wherein any one or more of the following aspects are provided to enable a plurality of users to select, store, organize, and manipulate and make use of the content information;
